(19) United States
(12) Patent Application Publication
(10) Pub. No.: US 2023/0074292 A1
(43) Pub. Date: Mar. 9, 2023

(54) POWER TRANSMISSION MECHANISM

(71) Applicant: FANUC CORPORATION, Yamanashi (JP)

(72) Inventor: Youhei YAMAGUCHI, Yamanashi (JP)

(21) Appl. No.: 17/800,380

(22) PCT Filed: Mar. 19, 2021
(86) PCT No.: PCT/JP2021/011304

§ 371 Date: Aug. 17, 2022

(30) Foreign Application Priority Data
Mar. 25, 2020 (JP) 2020-054604

(51) Int. Cl. F16H 7/14; F16H 7/02

(52) U.S. Cl. CPC F16H 7/14; F16H 7/02; F16H 2007/0842

(57) ABSTRACT

A power transmission mechanism includes: a first pulley driven about a first axis; a second pulley rotatable about a second axis, separated from and parallel to the first axis; and a third pulley rotatable about a third axis parallel to the first axis and between the first axis and the second axis. The third pulley is configured such that a large-diameter pulley having a larger diameter than the first pulley and a small-diameter pulley having a smaller diameter than the second pulley are coaxially fixed to each other. A first belt is looped between the first pulley and the large-diameter pulley. A second belt is looped between the small-diameter pulley and the second pulley. The third pulley is supported such that a position is adjustable, along a first plane orthogonal to the third axis, in a direction intersecting a second plane including the first axis and the second axis.

### CROSS-REFERENCE TO RELATED APPLICATION(S)

This is a National Stage Entry into the United States Patent and Trademark Office from International Patent Application No. PCT/JP2021/011304, filed on Mar. 19, 2021, which claims priority to Japanese Patent Application No. JP 2020-054604, filed on Mar. 25, 2020; the entire contents of both of which are incorporated herein by reference.

### FIELD OF THE INVENTION

The present disclosure relates to a power transmission mechanism.

### BACKGROUND OF THE INVENTION

There is disclosed a power transmission mechanism in which three pulleys having rotation axes parallel to one another are arranged at prescribed distances and are connected in series by individually winding transmission belts between the adjacent pulleys (for example, see Japanese Unexamined Patent Application, Publication No. Sho 60-48285). The rotation of a motor is transmitted while being decelerated in two stages by means of the power transmission mechanism.

### SUMMARY OF THE INVENTION

An aspect of the present disclosure is directed to a power transmission mechanism including: a first pulley rotationally driven about a first axis fixed to a housing; a second pulley supported so as to be rotatable about a second axis that is fixed to the housing so as to be separated from and parallel to the first axis; and a third pulley that is supported so as to be rotatable about a third axis parallel to the first axis and between the first axis and the second axis, wherein the third pulley is configured such that a large-diameter pulley having a larger diameter than the first pulley and a small-diameter pulley having a smaller diameter than the second pulley are coaxially fixed to each other, a first belt is looped between the first pulley and the large-diameter pulley, a second belt is looped between the small-diameter pulley and the second pulley, and the third pulley is supported such that a position thereof can be adjusted with respect to the housing, along a first plane orthogonal to the third axis, in a direction intersecting a second plane including the first axis and the second axis.

### BRIEF DESCRIPTION OF THE DRAWINGS

FIG. 1 is an overall configuration diagram showing a power transmission mechanism according to an embodiment of the present invention.

FIG. 2 is a plan view of the power transmission mechanism in FIG. 1.

FIG. 3 is a diagram showing a range in which a third axis is displaced in a case in which the tensile forces of both a first belt and a second belt of the power transmission mechanism in FIG. 1 are to be increased.

FIG. 4 is a schematic diagram for explaining a direction in which the third axis is displaced in a first modification of the power transmission mechanism in FIG. 1.

FIG. 5 is a schematic diagram for explaining a direction in which the third axis is displaced in a second modification of the power transmission mechanism in FIG. 1.

FIG. 6 is an overall configuration diagram showing a third modification of the power transmission mechanism in FIG. 1.

### DETAILED DESCRIPTION OF EMBODIMENT(S) OF THE INVENTION

A power transmission mechanism 1 according to an embodiment of the present disclosure will be described below with reference to the drawings.

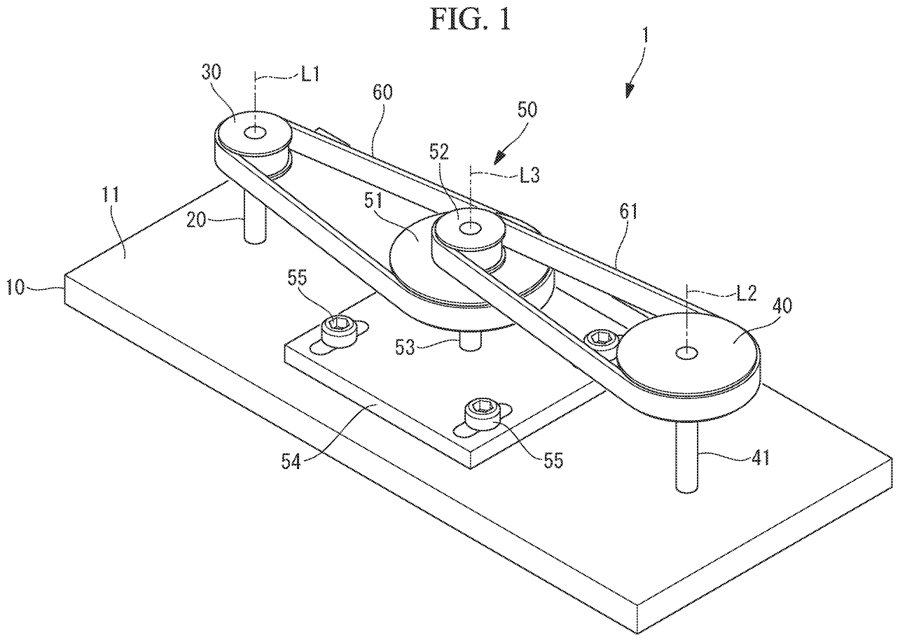

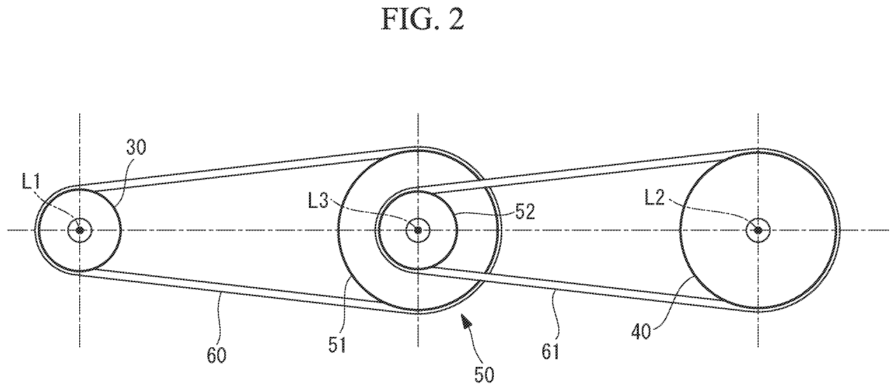

As shown in FIGS. 1 and 2, the power transmission mechanism 1 according to this embodiment includes a shaft 20 that is supported by a housing 10 so as to be rotatable about a first axis L1 and a first pulley 30 that is fixed to the shaft 20. The shaft 20 is connected to a motor (not shown) and rotates the first pulley 30 as a result of being rotationally driven about the first axis L1 by means of the motive power of the motor.

The power transmission mechanism 1 includes a shaft 41 that is supported by the housing 10 so as to be rotatable about a second axis L2 and a second pulley 40 that is fixed to the shaft 41. The shaft 41 is connected to a driven portion (not shown).

The power transmission mechanism 1 includes a third pulley 50 that is supported by the housing 10 so as to be rotatable about a third axis L3. The third axis L3 is disposed at an intermediate position between the first axis L1 and the second axis L2 so as to be parallel to the first axis L1 and the second axis L2.

The third pulley 50 includes a large-diameter pulley 51 having a diameter larger than the diameter of the first pulley 30 and a small-diameter pulley 52 having a diameter smaller than the diameter of the second pulley 40. The large-diameter pulley 51 and the small-diameter pulley 52 are coaxially arranged and integrally fixed to each other so as to be stacked in the thickness direction.

The power transmission mechanism 1 includes: a first belt 60 that is looped between the first pulley 30 and the large-diameter pulley 51 of the third pulley 50; and a second belt 61 that is looped between the small-diameter pulley 52 of the third pulley 50 and the second pulley 40. The first belt 60 and the second belt 61 are, for example, timing belts, and each of the first pulley 30, the second pulley 40, and the third pulley 50 is a timing belt pulley.

In this embodiment, the third pulley 50 is supported so as to be rotatable about the third axis L3 with respect to a shaft 53 extending along the third axis L3. The shaft 53 is fixed to a flat plate-shaped base member 54 that is disposed, in a close contact state, on an installation surface (first plane) 11 of the housing 10, which is orthogonal to the third axis L3.

The base member 54 is provided with a plurality of, for example, four elongated holes extending in parallel in the same direction. In order to fix the base member 54 to the housing 10, the base member 54 is disposed on the installation surface 11 of the housing 10 such that longitudinal axes of the elongated holes are oriented in a direction orthogonal to a plane (second plane) including the first axis L1 and the second axis L2. Then, bolts 55 that are inserted into the elongated holes are fastened into screw holes provided in the housing 10. By doing so, the base member 54 can be fixed to the housing 10.

The operation of the thus-configured power transmission mechanism 1 according to this embodiment will be described below.

With the power transmission mechanism 1 according to this embodiment, as shown in FIGS. 1 and 2, the shaft 20 is rotationally driven by means of the operation of the motor, and the first pulley 30 is rotated about the first axis L1.

The rotation of the first pulley 30 is transmitted to the large-diameter pulley 51 by means of the first belt 60.

At this time, the rotation of the first pulley 30 is transmitted to the third pulley 50 while being decelerated in accordance with the ratio of the diameter of the first pulley 30 to the diameter of the large-diameter pulley 51.

Subsequently, the rotation of the third pulley 50 is transmitted to the second pulley 40 by means of the second belt 61 looped between the small-diameter pulley 52 and the second pulley 40.

At this time, the rotation of the third pulley 50 is transmitted to the second pulley 40 while being decelerated in accordance with the ratio of the diameter of the small-diameter pulley 52 to the diameter of the second pulley 40.

With this configuration, the rotation of the first pulley 30 is transmitted to the second pulley 40 while being decelerated in two stages.

Next, a method of adjusting the tensile forces of the first belt 60 and the second belt 61 in the power transmission mechanism 1 according to this embodiment will be described.

In order to adjust the tensile forces of the first belt 60 and the second belt 61, the bolts 55 fixing the base member 54 to the housing 10 are loosened, and the base member 54 is slid on the installation surface 11.

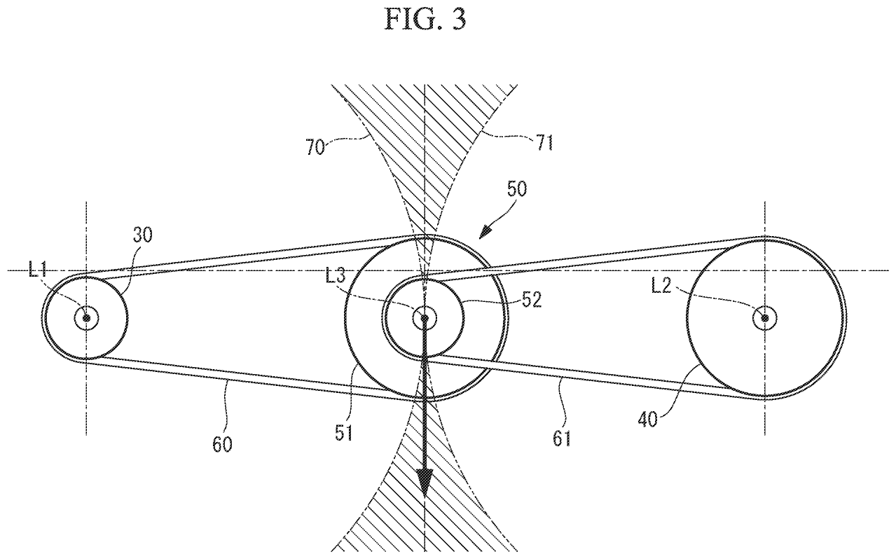

Specifically, the base member 54 is slid in the longitudinal axis direction of the elongated holes while the bolts 55 are kept inserted through the elongated holes. By doing so, as shown in FIG. 3, the third axis L3 of the third pulley 50 is displaced in a direction orthogonal to the plane including the first axis L1 and the second axis L2.

As a result, both the interaxial distance between the first axis L1 and the third axis L3 and the interaxial distance between the second axis L2 and the third axis L3 are increased at the same ratio, and the tensile forces of both the first belt 60 and the second belt 61 are increased. The bolts 55 are tightened again, at positions where the tensile forces of the first belt 60 and the second belt 61 are increased by required amounts, to fix the base member 54 to the housing 10, whereby the adjustment of the tensile forces is completed.

In this embodiment, it is possible to adjust the tensile forces of both the first belt 60 and the second belt 61 by moving the third pulley 50 in one direction orthogonal to the second plane. By configuring the first belt 60 and the second belt 61 so as to have the same dimensions and material, and also by setting the distance between the first axis L1 and the third axis L3 to be equal to the distance between the third axis L3 and the second axis L2, it is possible to adjust the tensile forces of the first belt 60 and the second belt 61 at the same ratio.

As described above, with the power transmission mechanism 1 according to this embodiment, the structure in which only the third pulley 50 is supported so as to be movable in one direction makes it possible to adjust the tensile forces of the two belts. There is an advantage in that the structure can be simplified as compared with a conventional structure in which two pulleys are movably supported.

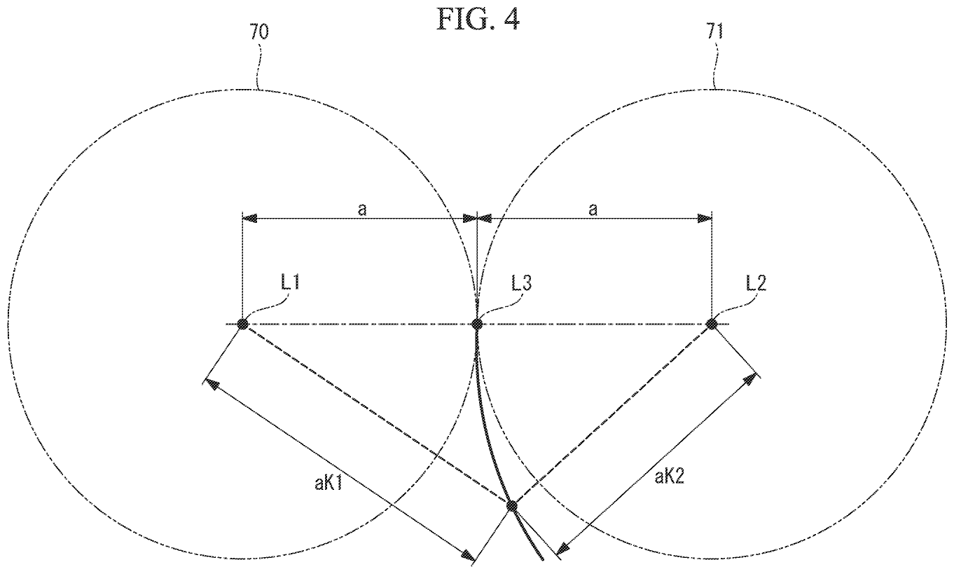

Note that, although the case in which the third pulley 50 is linearly moved in a direction orthogonal to the second plane has been illustrated as an example in this embodiment, alternatively, the third pulley 50 may be moved in a direction other than the direction orthogonal to the second plane, as shown in FIG. 4. In this case, the third axis L3 may be moved in a region radially outside of a first cylindrical surface 70, which is centered on the first axis L1 and includes the third axis L3, and radially outside of a second cylindrical surface 71, which is centered on the second axis L2 and includes the third axis L3.

By doing so, both the interaxial distance between the first axis L1 and the third axis L3 and the interaxial distance between the second axis L2 and the third axis L3 can be increased, and thus, the tensile forces of both the first belt 60 and the second belt 61 can be increased.

In this case, as shown in FIG. 4, the third pulley 50 may be moved, in the abovementioned region, along a curve in which the ratio of the elongation amount of the first belt 60 to the elongation amount of the second belt 61 is a constant value. By doing so, it is possible to appropriately adjust the tensile forces of both the first belt 60 and the second belt 61 at the same time, even in a case in which the adjustment amounts for appropriately adjusting the tensile forces of the two belts are different. In this case, the elongated holes provided in the base member 54 may be configured so as to have a shape corresponding to the abovementioned curve.

In an example shown in FIG. 4, the interaxial distance between the first axis L1 and the third axis L3 is increased at a rate of increase K1, and the interaxial distance between the second axis L2 and the third axis L3 is increased at a rate of increase K2. The curve in FIG. 4 is a curve in which the ratio of the rate of increase K1 to the rate of increase K2 is a constant value which is not 1, and by moving the third pulley 50 along said curve, it is possible to increase the tensile forces of the first belt 60 and the second belt 61 at a constant ratio.

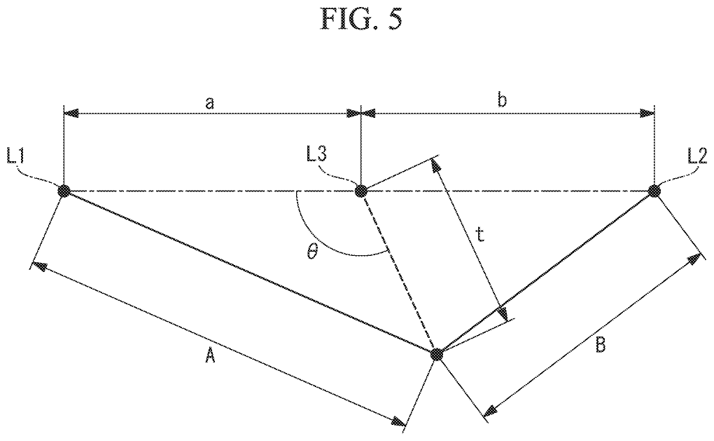

In addition, in this embodiment, the position of the third axis L3 can be adjusted along the first plane, in a single direction orthogonal to the second plane. Alternatively, as shown in FIG. 5, the position of the third axis L3 may be adjusted along the first plane, in a direction forming an angle other than 90° relative to the second plane.

In an example shown in FIG. 5, the third axis L3 is displaced with respect to the second plane by a movement amount t in a direction intersecting the second plane at an angle θ. By doing so, the tensile force of the first belt 60 and the tensile force of the second belt 61 are adjusted at ratios different from each other.

In addition, the angle θ formed by the movement direction of the third axis L3 and the second plane and the movement amount t, and the position of the third axis L3 have a relationship represented by the following equation.

$$cos θ = \frac{( {a}^{2} - {b}^{2} - {A}^{2} + {B}^{2} ) \sqrt{a + b}}{2 ( a + b ) \sqrt{a ( {B}^{2} - {b}^{2} ) + b ( {A}^{2} - {a}^{2} )}} \qquad Eq . 1$$

Here, a indicates the interaxial distance between the first axis L1 and the third axis L3 before movement, and b indicates the interaxial distance between the second axis L2 and the third axis L3 before movement. In addition, A indicates the interaxial distance between the first axis L1 and the third axis L3 after movement, and B indicates the interaxial distance between the second axis L2 and the third axis L3 after movement.

$$t = \sqrt{\frac{a ( {B}^{2} - {b}^{2} ) + b ( {A}^{2} - {a}^{2} )}{( a + b )}} \qquad Eq . 2$$

Therefore, by adjusting the angle θ formed by the movement direction of the third axis L3 and the second plane and the movement amount t, it is possible to adjust the tensile forces of the first belt 60 and the second belt 61 to magnitudes different from each other. In this case, the movement direction of the third axis L3 is a single linear direction, and thus, a simpler structure can be achieved.

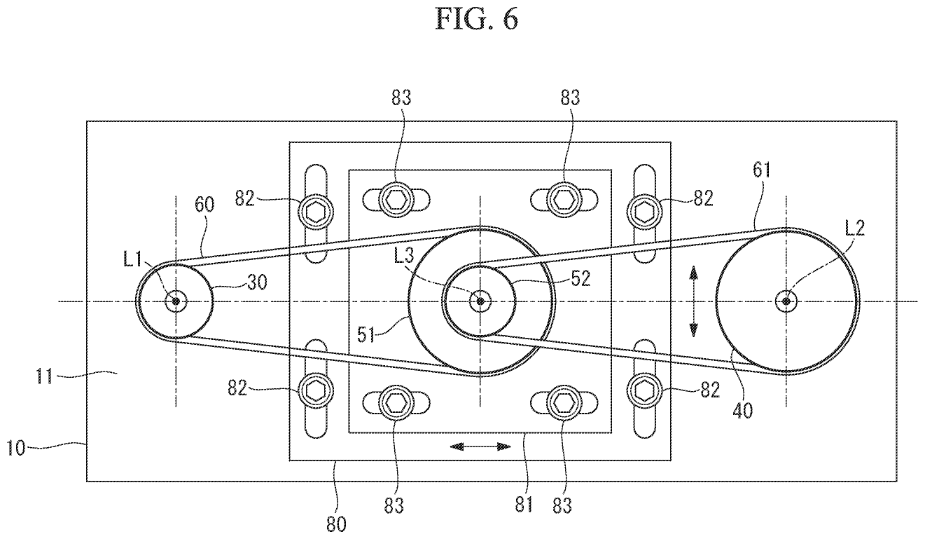

Although the case in which the position of the third axis L3 is adjusted only in a single direction has been illustrated as an example in this embodiment, alternatively, the position of the third axis L3 may be adjusted along the first plane, in two directions intersecting each other, as shown in FIG. 6.

In an example shown in FIG. 6, a first base member 80 is supported on the housing 10 so as to be movable along a direction (first direction) orthogonal to the second plane. In addition, a second base member 81 to which the shaft 53 is fixed is supported on the first base member 80 so as to be movable along a direction (second direction) parallel to the second plane.

With this configuration, the third axis L3 can be moved in two directions intersecting each other so as to be disposed at an arbitrary position, and thus, it is possible to appropriately adjust the tensile forces of both the first belt 60 and the second belt 61.

In other words, with the power transmission mechanism 1 according to this aspect, there are two parameters for adjusting the tensile forces of the first belt 60 and the second belt 61; therefore, it is possible to adjust the tensile forces more finely and to improve the precision of the work for adjusting the tensile forces of the two belts.

Although the case in which the third axis L3 is displaced from the position included in the second plane has been described in this embodiment, alternatively, the third axis L3 before displacement may be located at a position outside the second plane. In this case also, the third axis L3 is moved into a region where a region outside the first cylindrical surface 70, which is centered on the first axis L1 and includes the third axis L3, overlaps a region outside the second cylindrical surface 71, which is centered on the second axis L2 and includes the third axis L3. By doing so, it is possible to increase the tensile forces of the first belt 60 and the second belt 61 at the same time.

Although the case in which the third axis L3 is moved from the state in which the third axis L3 is disposed at the central position between the first axis L1 and the second axis L2 has been described in this embodiment, alternatively, the third axis L3 may be disposed at a position closer to one of the first axis L1 and the second axis L2.

1. A power transmission mechanism comprising:
a first pulley rotationally driven about a first axis fixed to a housing;
a second pulley supported so as to be rotatable about a second axis that is fixed to the housing so as to be separated from and parallel to the first axis; and
a third pulley that is supported so as to be rotatable about a third axis parallel to the first axis and between the first axis and the second axis,
wherein the third pulley is configured such that a large-diameter pulley having a larger diameter than the first pulley and a small-diameter pulley having a smaller diameter than the second pulley are coaxially fixed to each other,
a first belt is looped between the first pulley and the large-diameter pulley,
a second belt is looped between the small-diameter pulley and the second pulley, and
the third pulley is supported such that a position thereof can be adjusted with respect to the housing, along a first plane orthogonal to the third axis, in a direction intersecting a second plane including the first axis and the second axis.

2. The power transmission mechanism according to claim 1, wherein a position of the third axis can be adjusted in a region where a region radially outside of a first cylindrical surface, which is centered on the first axis and in which an interaxial distance between the first axis and the third axis serves as a radius thereof, overlaps a region radially outside of a second cylindrical surface, which is centered on the second axis and in which an interaxial distance between the second axis and the third axis serves as a radius thereof.

3. The power transmission mechanism according to claim 1, wherein the position of the third axis can be adjusted in a single movement direction.

4. The power transmission mechanism according to claim 1, wherein the position of the third axis can be adjusted with respect to the housing, along the first plane, in a first direction intersecting the second plane and a second direction intersecting the first direction.
